(19) United States
(12) Patent Application Publication
(10) Pub. No.: US 2003/0173463 A1
(43) Pub. Date: Sep. 18, 2003

(54) Spaceshuttle double observatory

(76) Inventor: Zoltan Herpay, London (GB)

Correspondence Address: Dr. Zoltan Herpay, 28 Dudley Court, 36 Endell street, London, WC2 9RD, GB

(21) Appl. No.: 10/100,730

(22) Filed: Mar. 18, 2002

(51) Int. Cl. B64G 1/22; B64G 1/00

(52) U.S. Cl. 244/158 R

(57) ABSTRACT

A Spaceshuttle Double Observatory of a singular system, in which the spaceshuttle is a self-launching-lifting body, having a two-ringed fuselage, in which the inner or central fuel tank could move outwardly towards the tail, when empty, however this slipping movement could pull to the centre a two-sided, two main reflectors covered observatory, and as it goes out, still it pulls a second secondary reflector to the tail-end, leaving behind a large opening without the need for extra star-doors, while at the top-cone the originally fixed first secondary is opened out with star-doors, thus the two telescopes, opened to the two opposite ends, could introduce a new tipe of observational astronomy, which was unknown before, by which the centre of the Universe could be detected perhaps together with the life-generating regions, or the most effective implosion regions that supply the creation-fields.

This invention relates to a spaceshuttle double observatory of a singular system, in which the central part of the fuselage of a large, self-lifting spaceshuttle provides means for the opening of a centrally positioned double observatory with two telescopes, the nozzle-telescope, and the tail-telescope, and both of these are positioned as the central fuel tank is slipping out, when it becomes empty soon after the arrival to space.

In the present art a spaceshuttle is not yet a self-lifting body, and a space-observatory is not yet in the close co-operation with a large, self-lifting spaceshuttle. When the latter is in trouble, it would need the support of a very expensive visiting station. Still another-problem is that the Hubble-Observatory is rather mediocre in size. It could not offer satisfactory works in many crucially important directions. It is fundamentally a copy of the old telescopes with a little electronically operative observatory behind the main reflector, whose exact oppositional side could probably never be observed.

According to the present invention there is a possibility to unify the greatly enlarged spaceshuttle of a self-lifting body with a double observatory, whose aim is the introduction of a new tipe of observational astronomy, in which the most powerful observation could be carried out always in the two perfectly opposite directions, by which we would find soon our better central position but apart from that, we could also find many crucially important data about the supposedly most dense outermost region, in which life is most probably created continuously, and billions of the little microcosmical life-carriers are pushed towards us implosively. When the large spaceshuttle arrives to space and its central tank is employ, it could be jettisoned, and as it is slipping towards the tail together with its stopped central engine, it pulls a double observatory with its two main mirrors to the centre of the fuselage, where it is the most shielded, and further on it is still pulling towards the tail a second secondary reflector, opening the tail-telescope, as it goes. At the same time the first secondary reflector remains fixed in the nose of the fuselage, as a part of the first or nose-telescope. This could be opened out to the sky with a star door system, whose intricate body should be covered with ablation layers that would not stick the star-doors before observation, only in the reentry. At least one nose- wheel or landing geer should be positioned in this nose-telescope.

A specific embodyment of the invention will now be described by way of example with reference to the accompanying drawing in which:

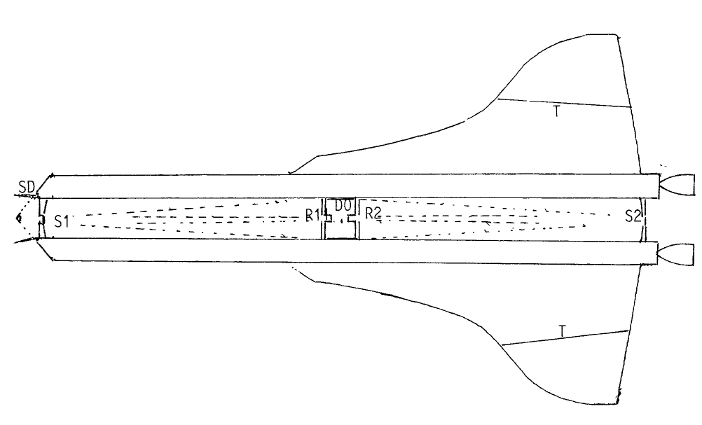

FIG. 1 shows the cross-section of the top planar view of the whole Spaceshuttle Double Obeservatory, as the outgoing central fuel tank is positioning the double observatotory DO with its two main reflectors R1 and R2 to the centre of the fuselage, and still pulling the second “secondary” reflector S2 to the tail of the fuselage, making the the tail-telescope open, as the empty tank goes. At the same time the fixed first “secondary” holding nose-cone is opened out for the nose-telescope by means of star-doors, making the central tubular body of the double ringed fuselage open for observation at bot sides, while the large wing-tips could be turned towards the sun.

Referring to this singular FIG. 1 drawing, perhaps the most intricate part of this system is the nose-cone, which have to be covered with a strong ablation layer, yet it have to be opened out when it starts to to work in space A carefully designed star-door could solve this problem (not shown) which is opening out easily, for graphite coated cuttings on the ablation layers are allowing easy openings on these doors before the burnings in reentry. Similar problems are with the reentry burnings of the ablation materials on the landing gears opening doors, which are already solved. Another crusial part is the two wing tip area, which have to be mobilized towards the sun in space-works, but whose lower surfaces particularly well covered with ablation layers.

1. A Spaceshuttle Double Observatory of a whole system, in which the Spaceshuttle is a large self-lifting body with a sufficiently long (and wide double ringed fuselage, whose central tubular body is a removable fuel tank, which could pull the components of a double observatory into position, as it goes, making the fuselage open for two observatories, working in two opposite directions, with a star-door opening at the nose-cone, but the large winged lifting body remains together with its tro observatories, fending the same with solar radiation generated electric power from the rotary wing-tips, as the two telescopes using double observatory is opened out always in two perfectly oppositional (directions, by which a new tipe of observational astronomy could be developed

2. A Spaceshuttle Double Obeservatory as claimed in claim 1 in which the nose cone of the fuselage is also the nose-cone of the first telescope, which have to be opened out in space with its specially protected, ablation layers covers star-doors, but in reentry at least this nose-telescope is connected to the mechanism chanism of a nose-gear for the supportance of its structure in landing.

3. A Spaceshuttle Double Observatory as claimed in claims 1 and 2, in which the observatory is covered with two main reflectors at its two sides, while its disk-rim is always positioned in a well shielded position.
